(19) United States
(12) Patent Application Publication
(10) Pub. No.: US 2011/0229255 A1
(43) Pub. Date: Sep. 22, 2011

(54) TOOL JOINT

(76) Inventor: Cheng-Wei SU, Taichung City (TW)

(21) Appl. No.: 13/046,732

(22) Filed: Mar. 12, 2011

(30) Foreign Application Priority Data
Mar. 19, 2010 (TW) 099108103

(51) Int. Cl. F16C 11/06

(52) U.S. Cl. 403/122

(57) ABSTRACT

A tool joint comprises a first rod, a pressing assembly, a second rod and a positioning element. Through a notch formed in the first rod, the first rod can be adjusted to be vertical to the second rod, thus increasing one driving method of the second rod with respect to the first rod. Thereby, the tool joint includes two operation modes, enhancing the applicability.

### BACKGROUND OF THE INVENTION

1. Field of the Invention

The present invention relates to a tool capable of being adjusted to various working angle, and more particularly to a tool joint.

2. Description of the Prior Art

Referring to FIG. 1, a conventional tool joint capable of being adjusted to any angle comprises a first rod 11 and a second rod 12 that are pivoted to each other. The first rod 11 has an end 111 adapted to be drivingly connected to a drive tool (not shown) which may be a pneumatic tool or a ratchet wrench. The second rod 12 has an end 121 adapted to be engaged with a socket (not shown). The drive tool can drive the socket at various angles through the tool joint, enhancing convenience in use while widening the applicability range. However, the above tool joint still suffers from the following defects in actual application:

When in use, the drive tool directly drives the first rod to rotate through the tool joint, and then the first rod 11 will drive the second rod 12 to rotate to finish the screwing/unscrewing operation, so that the second rod 12 can only be driven by the rotation of the first rod 11 without any other driving methods, thus limiting its applicability.

The present invention has arisen to mitigate and/or obviate the afore-described disadvantages.

### SUMMARY OF THE INVENTION

The primary objective of the present invention is to provide a tool joint whose applicability is enhanced due to two operation modes.

Hence, to achieve the above objective, a tool joint in accordance with the present invention comprises a first rod, a pressing assembly, a second rod, and a positioning element.

The first rod includes a first working portion and a pivoting portion at both ends thereof. The pivoting portion is formed with a pivoting groove in an axial direction of the first rod, and the pivoting groove includes a receiving groove in a bottom surface thereof. The pivoting groove is further formed with two limiting grooves in an inner peripheral surface thereof, and between the two limiting grooves of the pivoting groove is formed a notch.

The pressing assembly is compressibly disposed in the receiving groove.

The second rod includes a second working portion and a ball portion at both ends thereof, and between the second working portion and the ball portion is formed a neck portion. The ball portion includes a bolt, and both ends of the bolt protrude from an outer peripheral surface of the ball portion. The ball portion is pivoted in the pivoting groove of the first rod, and the pressing assembly pushes against the outer peripheral surface of the ball portion. The two ends of the bolt are disposed in the two limiting grooves of the pivoting grooves, respectively, and the neck portion of the second rod is engaged into or disengaged from the notch of the first rod.

The positioning element is disposed in the pivoting portion of the first rod and partially presses against the outer peripheral surface of the ball portion for preventing the second rod from disengaging from the first rod.

The present invention will be clearer from the following description when viewed together with the accompanying drawings, which show, for purpose of illustrations only, the preferred embodiments in accordance with the present invention.

### BRIEF DESCRIPTION OF THE DRAWINGS

FIG. 1 is a perspective view of a conventional tool joint;

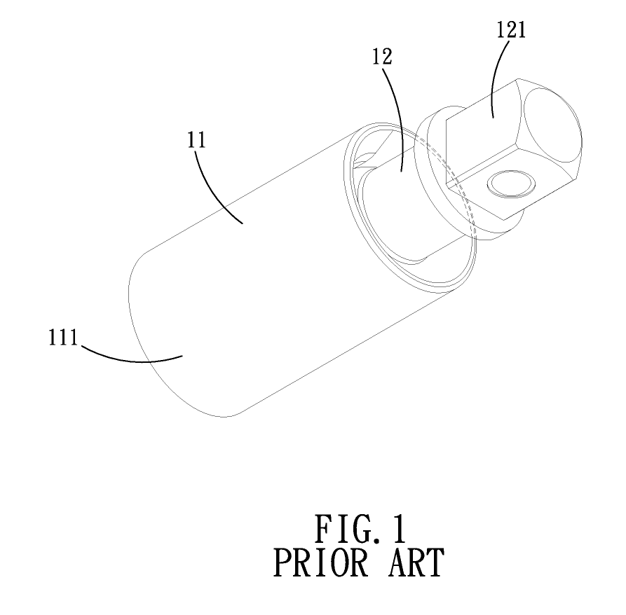

FIG. 2 is an exploded view of a tool joint in accordance with the present invention;

FIG. 3 is a perspective view of the tool joint in accordance with the present invention;

FIG. 4 is a first cross-sectional view of the tool joint in accordance with the present invention;

FIG. 5 is a second cross-sectional view of the tool joint in accordance with the present invention;

FIG. 6 is a first operational view of the tool joint in accordance with the present invention;

FIG. 7 is a second operational view of the tool joint in accordance with the present invention;

FIG. 8 is a third operational view of the tool joint in accordance with the present invention;

FIG. 9 is a cross-sectional view of another tool joint in accordance with the present invention;

FIG. 10 is a third cross-sectional view of the present invention, showing that the bolt is integrally formed on the ball portion of the second rod;

FIG. 11 is an exploded view of another tool joint in accordance with the present invention;

FIG. 12 is a cross-sectional view of another tool joint in accordance with the present invention;

FIG. 13 is an exploded view of another tool joint in accordance with the present invention; and

FIG. 14 is a cross-sectional view of FIG. 13.

### DETAILED DESCRIPTION OF THE PREFERRED EMBODIMENTS

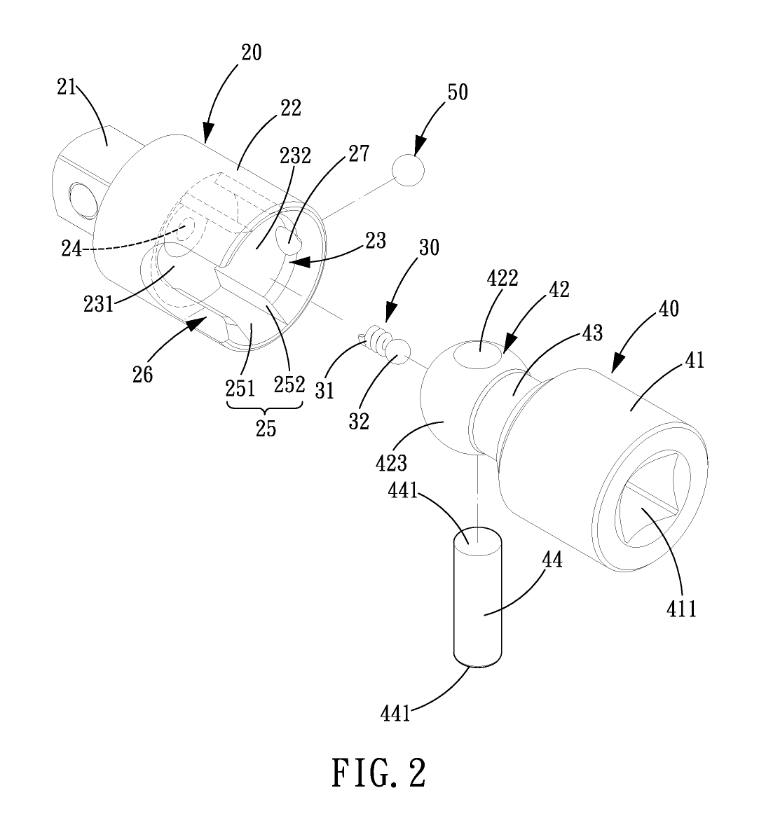

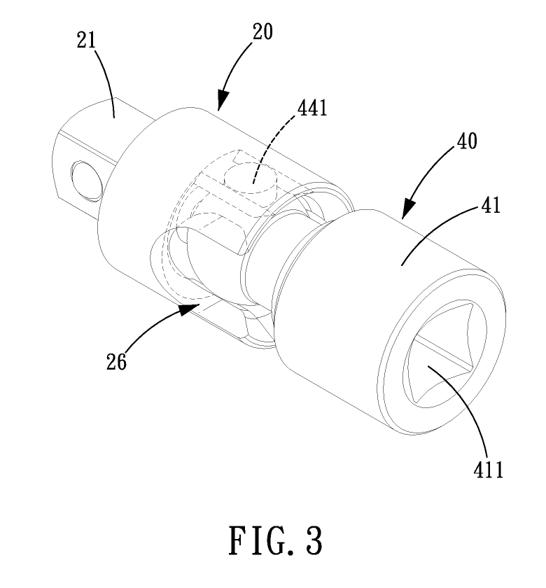

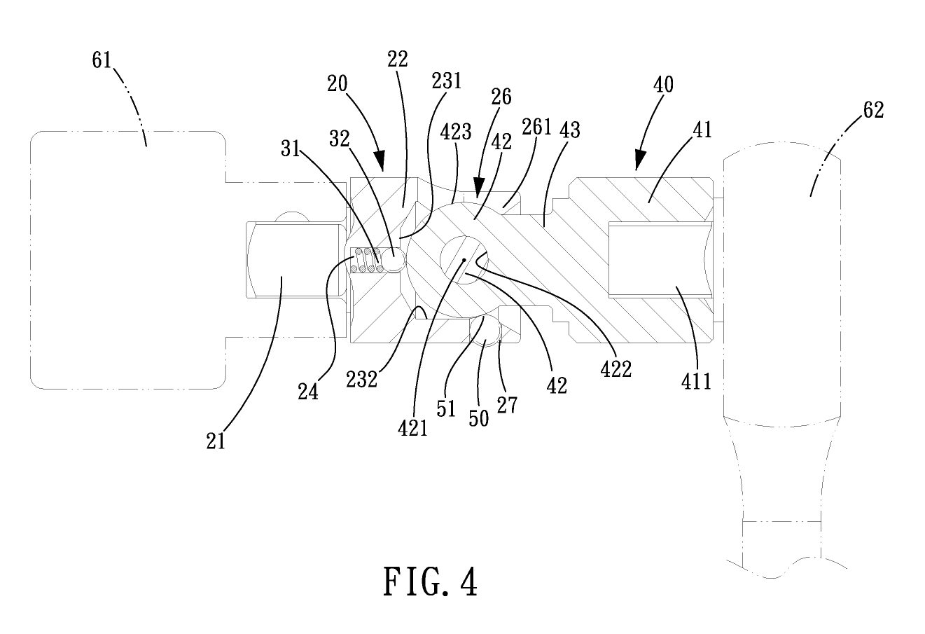

Referring to FIGS. 2-5, a tool joint in accordance with a first embodiment of the present invention comprises a first rod 20, a pressing assembly 30, a second rod 40 and a positioning element 50.

The first rod 20 includes a first working portion 21 and a pivoting portion 22 at both ends thereof. The first working portion 21 is cylinder-shaped and adapted to be engaged with a socket 61. The pivoting portion 22 is formed with a pivoting groove 23 in an axial direction of the first rod 20. The pivoting groove 23 includes a receiving groove 24 in a bottom surface 231 thereof. The pivoting groove 23 is further formed with two limiting grooves 25 in an inner peripheral surface 232 thereof in the axial direction of the first rod 20. The respective limiting grooves 25 are defined by a bottom surface 251 and two side surfaces 252 connected to both ends of the bottom surface 251. Between the two limiting grooves 25 is formed a notch 26. The pivoting portion 22 includes a through hole 27 which is located adjacent to an opening of the pivoting groove 23 and extends to the pivoting groove 23.

The pressing assembly 30 is compressibly disposed in the receiving groove 24. In the present embodiment, the pressing assembly 30 includes a spring 31 and a steel ball 32 constantly pushed toward the opening of the receiving groove 24 by the spring 31.

The second rod 40 includes a second working portion 41 and a ball portion 42 at both ends thereof. Between the second working portion 41 and the ball portion 42 is formed a neck portion 43. The second working portion 41 includes an engaging groove 411 for insertion of a drive tool 62 which is a ratchet wrench in the present embodiment. The ball portion 42 includes a ball center 421 and an insertion hole 422 for insertion of a bolt 44. The bolt 44 has both ends 441 protruding out of an outer peripheral surface 423 of the ball portion 42. Each of the two ends 441 has a curved end surface. The ball portion 42 is pivoted in the pivoting groove 23 of the first rod 20 in such a manner that the steel ball 32 pushes against the outer peripheral surface 423 of the ball portion 42. The ball center 421 is located closer to the bottom surface 231 of the pivoting groove 23 than the insertion hole 422, and both ends 441 of the bolt 44 are disposed in the two limiting grooves 25 of the first rod 20. Furthermore, the neck portion 43 is engaged into or disengaged from the notch 26 of the first rod 20.

The positioning element 50 is in the form of a ball and includes a pressing portion 51. The positioning element 50 is inserted into the through hole 27 of the first rod 20, and the pressing portion 51 presses against the outer peripheral surface 423 of the ball portion 42 of the second rod 40 for preventing the second rod 40 from disengaging from the first rod 20.

The aforementioned is the summary of the positional and structural relationship of the respective components of the preferred embodiment in accordance with the present invention.

Thereby, the second rod 40 is able to drive the first rod 20 in two methods which are explained as follows:

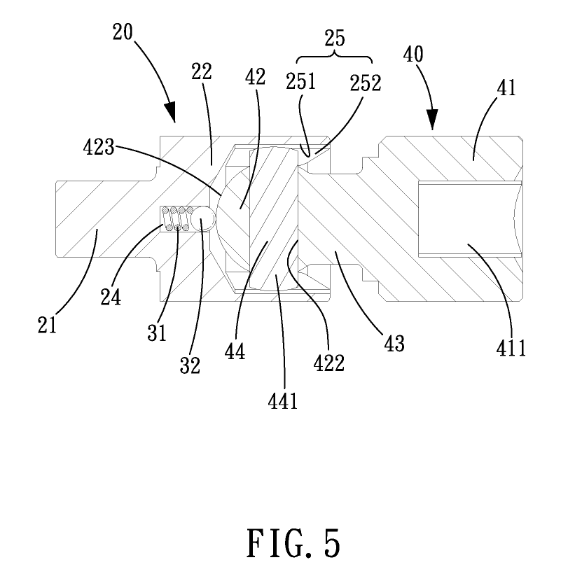

Firstly, as shown in FIG. 5, the angle between the first rod 20 and the second rod 40 is adjusted in such a manner that the neck portion 43 of the second rod 40 is not engaged in the notch 26 of the first rod 20. Since the bolt 44 of the second rod 40 is inserted into and limited by the two limiting grooves 25 of the first rod 20, when the second rod 40 is driven by the drive tool 62 to rotate, the first rod 20 will rotate synchronously. Consequently, the socket 61 connected to the first rod 20 can be used to perform the screwing/unscrewing operation.

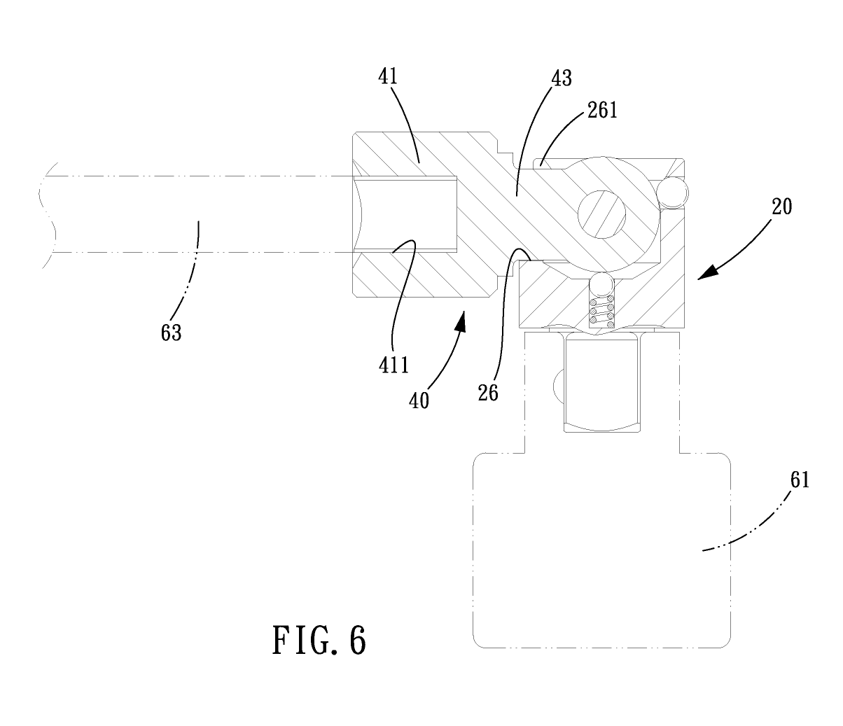

Secondly, as shown in FIG. 6, when the angle between the first rod 20 and the second rod 40 is adjusted in such a manner that the neck portion 43 of the second rod 40 is engage into the notch 26 of the first rod 20, the first rod 20 is vertical to the second rod 40. The drive tool 63 which is inserted into the engaging groove 411 of the second working portion 41 of the second rod 40 may be a rod, so that when the drive tool 63 is turned, the second rod 40 can be driven to rotate since the neck portion 43 of the second rod 40 is limited by side walls 261 of the notch 26. Consequently, the socket 61 connected to the first rod 20 can be used to perform the screwing/unscrewing operation.

Hereby, the second rod 40 is able to drive the first rod 20 in the above two methods, thus assuredly enhancing the applicability of the tool joint in accordance with the present invention.

In addition, the angle of the second rod 40 with respect to the first rod 20 of the tool joint in accordance with the present invention can be adjusted in two directions.

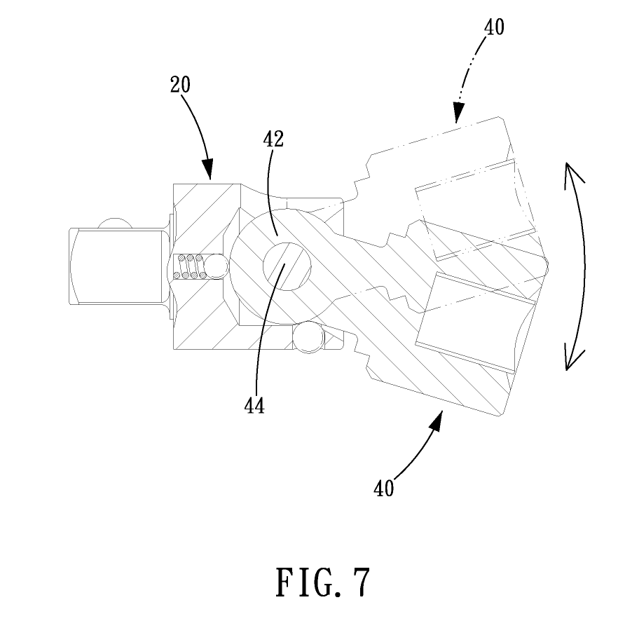

Firstly, referring to FIGS. 2 and 7, since the ball portion 42 of the second rod 40 is pivoted into the pivoting groove 23 of the first rod 20 through the bolt 44 while the two ends 441 of the bolt 44 are limited by the side surfaces 252 of the two limiting grooves 25, the second rod 40 is allowed to pivot around the bolt 44, thus adjusting the angle between the first rod 20 and the second rod 40 in a first direction.

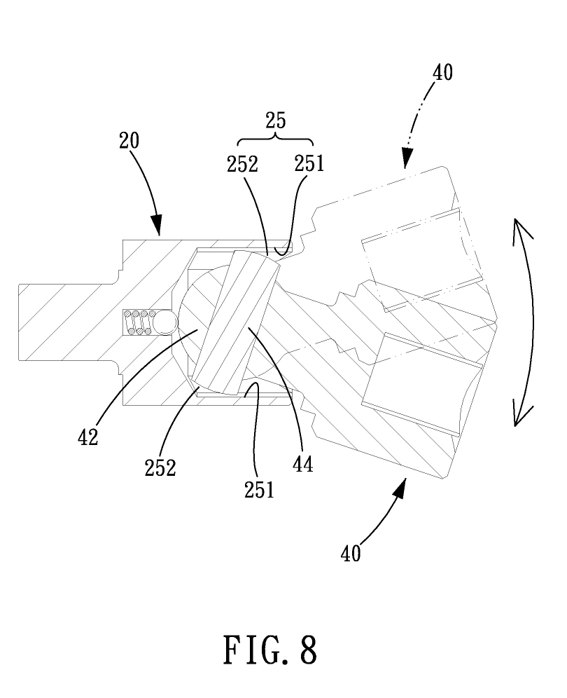

Secondly, referring to FIGS. 2 and 8, since the bolt 44 of the ball portion 42 of the second rod 40 is only limited by the side surfaces 252 of the limiting grooves 25 of the first rod 20, the second rod 40 is allowed to pivot toward the respective bottom surfaces 251 of the limiting grooves 25 of the first rod 20, thus adjusting the angle between the first rod 20 and the second rod 40 in a second direction.

It is to be noted that, when being adjusted in the second direction, the angle between the first and the second rods 20, 40 can also be synchronously adjusted in the first direction, further enhancing the applicability of the tool joint in accordance with the present invention.

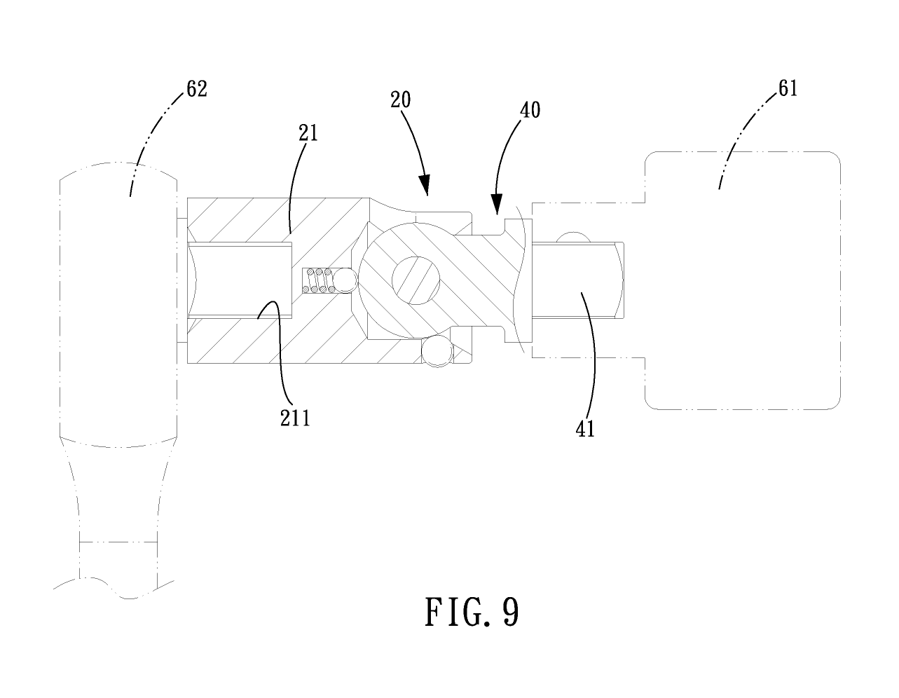

Referring to FIG. 9, preferably, the present invention provides a tool joint in accordance with a second embodiment in which a first rod 20 including an engaging groove 211 in a first working portion 21, and a second rod 40 including a cylinder-shaped second working portion 41, and the engaging groove 211 of the first rod 20 is adapted for insertion of the drive tool 62 while the second working portion 41 of the second rod 40 is adapted for engagement with a socket 61.

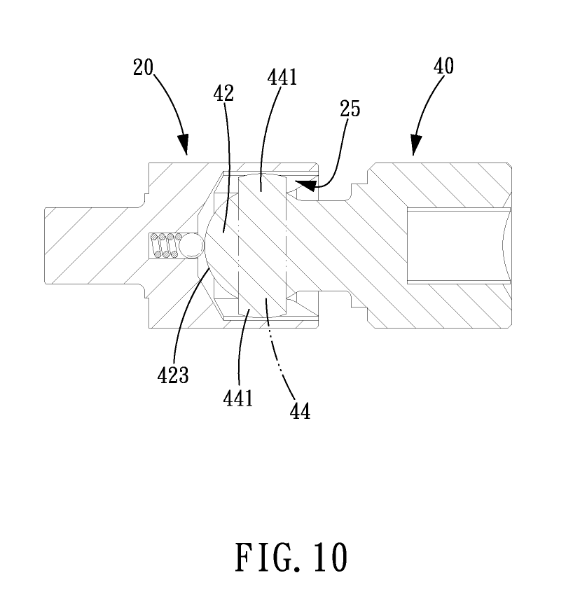

Referring to FIG. 10, preferably, the present invention provides a tool joint in accordance with a third embodiment in which a bolt 44 is integrally formed on the ball portion 42 of the second rod 40 and has both ends 441 protruding from the outer peripheral surface 423 of the ball portion 42. The two ends 441 are disposed in the two limiting grooves 25 of the first rod 20 in the same manner.

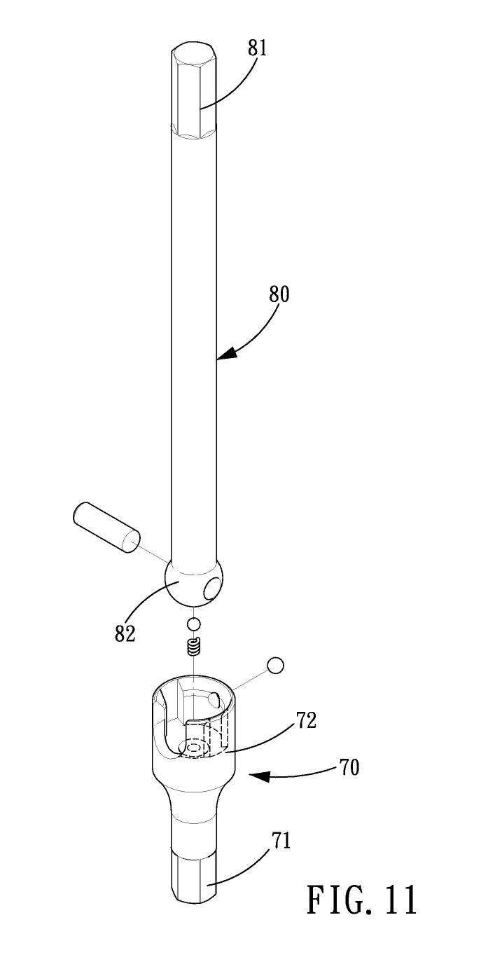

Referring to FIG. 11, preferably, the present invention provides a tool joint in accordance with a fourth embodiment of the present invention in which a first working portion 71 of a first rod 70 and a second working portion 81 of a second rod 80 are both hexagonal in cross section. By such arrangements, both the first working portion 71 and the second working portion 81 can be used as a handle rotated by user during screwing or unscrewing process or can be used to directly engage with a socket or a screw. The first rod 70 is also pivoted to a ball portion 82 of the second rod 80 through a pivoting portion 72 thereof. By such arrangements, the user can directly turn the first working portion 71 to drive the socket to perform the screwing/unscrewing operation or directly drive the screw to perform the screwing/unscrewing operation through the second working portion 81. Alternatively the user can directly turn the second working portion 81 to drive the socket to perform the screwing/unscrewing operation or directly drive the screw to perform the screwing/unscrewing operation through the first working portion 71.

Additionally, the first and the second working portions 71, 81 can also be in a form selected from the group consisting of plum blossom, cross, and a slot, so that the tool joint in accordance with the present invention can be used to screw/unscrew different forms of elements.

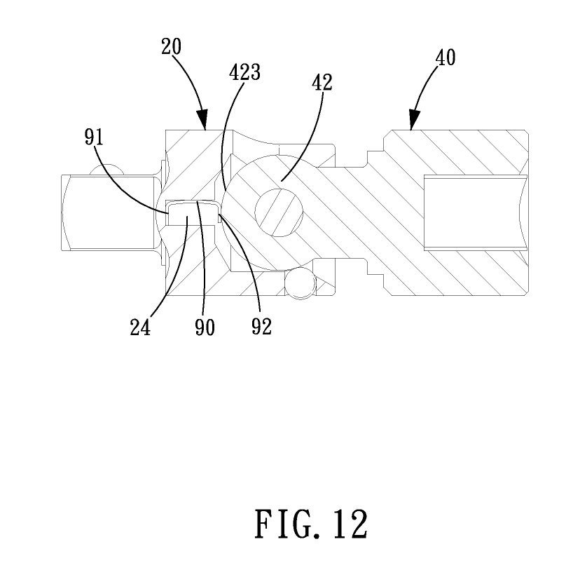

Referring to FIG. 12, besides including the spring and the steel ball, the pressing assembly in accordance with the present invention can also be an elastic sheet 90. The elastic sheet 90 includes a bottom portion 91 pressing against a bottom surface of the receiving groove 24, and a pressing portion 92 pressing against the outer peripheral surface 423 of the ball portion 42 of the second rod 40.

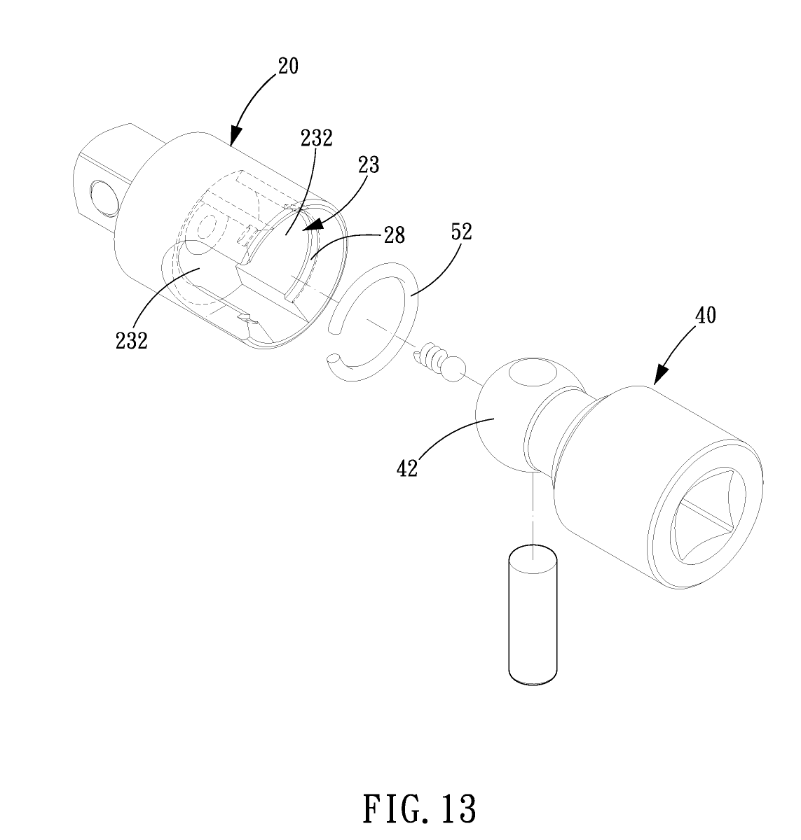

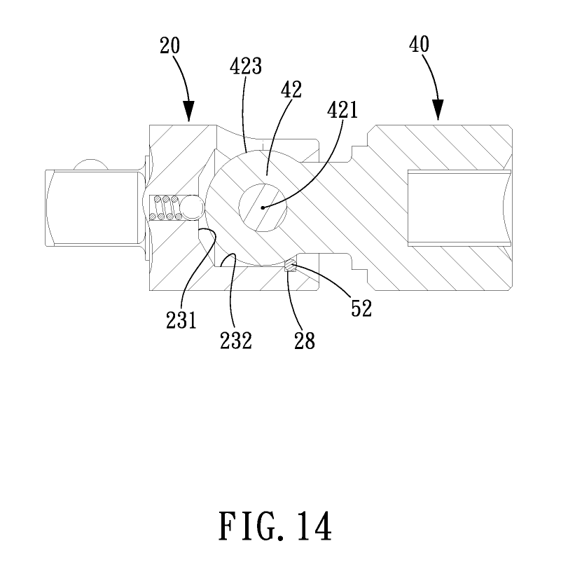

Finally, referring to FIGS. 13 and 14, the present invention provides a tool joint in accordance with a fifth embodiment of the present invention in which the pivoting groove 23 of the first rod 20 is further formed in the inner peripheral surface 232 with a curved groove 28 for accommodation of a positioning element 52. The positioning element 52 is a C-shaped buckle and partially presses against the outer peripheral surface 423 of the ball portion 42, preventing the second rod 40 from disengaging from the first rod 20. The ball portion 42 of the second rod 40 includes a ball center 421 which is located closer to the bottom surface 231 of the pivoting groove 23 than the curved groove 28.

While we have shown and described various embodiments in accordance with the present invention, it is clear to those skilled in the art that further embodiments may be made without departing from the scope of the present invention.

What is claimed is:

1. A tool joint comprising:
a first rod including a first working portion and a pivoting portion at both ends thereof, the pivoting portion being formed with a pivoting groove in an axial direction of the first rod, the pivoting groove including a receiving groove in a bottom surface thereof, the pivoting groove being further formed with two limiting grooves in an inner peripheral surface thereof, between the two limiting grooves of the pivoting groove being formed a notch;
a pressing assembly being compressibly disposed in the receiving groove;
a second rod including a second working portion and a ball portion at both ends thereof, between the second working portion and the ball portion being formed a neck portion, the ball portion including a bolt, both ends of the bolt protruding out of an outer peripheral surface of the ball portion, the ball portion being pivoted in the pivoting groove of the first rod, the two ends of the bolt being disposed in the two limiting grooves of the pivoting grooves, respectively, and the neck portion of the second rod being engaged into or disengaged from the notch of the first rod; and
a positioning element being disposed in the pivoting portion of the first rod and partially pressing against the outer peripheral surface of the ball portion for preventing the second rod from disengaging from the first rod.

2. The tool joint as claimed in claim 1, wherein the pivoting portion of the first rod includes a through hole extending to the pivoting groove, the positioning element is inserted into the through hole of the first rod, the ball portion of the second rod includes a ball center, the ball center is located closer to the bottom surface of pivoting groove than the through hole of the first rod.

3. The tool joint as claimed in claim 2, wherein the positioning element includes a pressing portion, the pressing portion of the positioning element presses against the outer peripheral surface of the ball portion of the second rod.

4. The tool joint as claimed in claim 1, wherein the respective limiting grooves are formed in the axial direction of the first rod and defined by a bottom surface and two side surfaces connected at both ends of the bottom surface.

5. The tool joint as claimed in claim 1, wherein the pressing assembly includes a spring and a steel ball constantly pushed toward the opening of the receiving groove by the spring.

6. The tool joint as claimed in claim 1, wherein the pressing assembly is an elastic sheet, the elastic sheet includes a bottom portion pressing against a bottom surface of the receiving groove, and a pressing portion pressing against the outer peripheral surface of the ball portion of the second rod.

7. The tool joint as claimed in claim 1, wherein the bolt is integrally formed on the ball portion of the second rod.

8. The tool joint as claimed in claim 1, wherein the first working portion of the first rod includes an engaging groove for insertion of a drive tool, the second working portion of the second rod is cylinder-shaped for engagement with a socket.

9. The tool joint as claimed in claim 1, wherein the first working portion of the first rod is cylinder-shaped for engagement with a socket, the second working portion of the second rod includes an engaging groove for insertion of a drive tool.

10. The tool joint as claimed in claim 1, wherein the first working portion of the first rod is hexagonal in cross section, and the second working portion of the second rod is hexagonal in cross section.

11. The tool joint as claimed in claim 1, wherein the pivoting groove of the first rod is further formed in the inner peripheral surface thereof with a curved groove for accommodation of the positioning element, the positioning element is a C-shaped buckle, the ball portion of the second rod includes a ball center which is located closer to the bottom surface of the pivoting groove than the curved groove.
